(19) United States
(12) Patent Application Publication
(10) Pub. No.: US 2022/0122559 A1
(43) Pub. Date: Apr. 21, 2022

(54) GOA CIRCUIT WITH BIDIRECTIONAL OUTPUTS AND SEAMLESSLY-JOINED SCREEN

(71) Applicant: TCL China Star Optoelectronics Technology Co., Ltd., Shenzhen, Guangdong (CN)

(72) Inventor: Xiaowen Lv, Shenzhen, Guangdong (CN)

(73) Assignee: TCL China Star Optoelectronics Technology Co., Ltd., Shenzhen, Guangdong (CN)

(21) Appl. No.: 16/761,687

(22) PCT Filed: Apr. 24, 2020
(86) PCT No.: PCT/CN2020/086664

§ 371 Date: May 5, 2020

(30) Foreign Application Priority Data
Mar. 31, 2020 (CN) 202010240305.5

(51) Int. Cl. G09G 3/36

(52) U.S. Cl. CPC G09G 3/3677

(57) ABSTRACT

The present invention discloses a gate-on-array (GOA) circuit with bidirectional outputs and a seamlessly-joined screen. The GOA circuit includes a first circuit, a pull-up module, a first output end, a second output end, a capacitor and a 41st transistor, wherein the capacitor and the second output end are connected in parallel and the 41st transistor and the first circuit are connected in parallel, and wherein the pull-up module is connected to the first circuit, the first circuit is connected to one of the first output end and the second output end, and the first output end is connected to a pull-down module.

### FIELD OF THE DISCLOSURE

The present invention relates to display technologies, and more particularly to a gate-on-array (GOA) circuit with bidirectional outputs and a seamlessly-joined screen.

### DESCRIPTION OF RELATED ARTS

Liquid crystal display (LCD) has many advantages such as thin body, power saving, no radiation, etc., and has been widely used. For example, LCD TVs, mobile phones, personal digital assistants (PDAs), digital cameras, computer screens or laptop screens dominate the field of flat panel displays.

Most of the LCDs on the existing market are backlight-type LCDs, which include LCD panels and backlight modules. The principle of a LCD panel is to pour liquid crystal molecules between a thin-film transistor array substrate (TFT Array Substrate) and a color filter substrate (CF Substrate), and control the direction of rotation of the liquid crystal molecules by applying a driving voltage on the two pieces of substrates so as to refract the light of the backlight module to generate or display an images.

As shown in an existing are depicted in FIG. 1, the existing GOA circuit has a single-directional output function. When a joined screen is implemented using the existing GOA circuit, a large gap causes the joined screen to be unsightly, resulting in more non-effective display area occupied. Also, a yield loss is gained by a cutting process, resulting in a rise of cost. It is not beneficial for narrow bezel or zero-bezel designs.

As shown in the existing art depicted in FIG. 2, the existing GOA circuit cannot meet the bezel-less design requirements of the joined screen.

### Technical Problems

The existing GOA circuit with single-directional outputs is not beneficial for meeting requirements of a seamless design of a joined screen, resulting in a large gap of the joined screen and affecting aesthetics and user experience, and at the same time resulting in high cutting yield and high cost.

### Technical Solutions

The present invention discloses a gate-on-array (GOA) circuit with bidirectional outputs, wherein the GOA circuit includes a first circuit, an eleventh transistor, a first output end, a second output end, a capacitor, a 41st transistor, a 211th transistor, a second transistor and a 21st transistor; wherein the capacitor and the second output end are connected in parallel and the 41st transistor and the first circuit are connected in parallel; wherein N is set to be a positive integer, in a Nth stage of the GOA circuit except for GOA units of a first stage and a last stage, a gate of the eleventh transistor is connected to a serial telecommunication (ST) signal, a source of the eleventh transistor is connected to a gate signal, a drain of the eleventh transistor is connected to the first circuit, the first circuit is connected to one of the first output end and the second output end, the first output end is connected to a pull-down module, the gate of the 211th transistor is connected to a signal of a Q node, the source of the 211th transistor is connected to a clock signal, the drain of the 211th transistor is connected to the first output end, the gate of the second transistor and the gate of the 21st transistor are connected to the signal of the Q node, the source of the second transistor is connected to the source of the 21st transistor, the drain of the second transistor is connected to the ST signal, the drain of the 21st transistor is connected to the second output end.

The present invention discloses a GOA circuit with bidirectional outputs. The GOA circuit includes a first circuit, a pull-up module, a first output end, a second output end, a capacitor C and a 41st transistor T41; wherein the capacitor and the second output end are connected in parallel and the 41st transistor and the first circuit are connected in parallel; N is set to be a positive integer, in a Nth stage of the GOA circuit except for GOA units of a first stage and a last stage, the pull-up module is connected to the first circuit, the first circuit is connected to one of the first output end and the second output end, the first output end is connected to a pull-down module.

The present invention further provides a seamlessly joined screen including at least two pieces of display screens including the GOA circuit with bidirectional outputs, wherein the GOA circuit is configured to drive the at least two pieces of display screens to display images and is disposed between the at least two display screens.

### Beneficial Effects

The GOA circuit with bidirectional outputs according to the present invention can solve the technical difficulty of a seamless design of the joined screen, greatly reduce the gap of the joined screen, improve its aesthetics and user experience, and at the same time reduce a cutting process for one time, improve the product yield and reduce the cost.

### DESCRIPTION OF DRAWINGS

FIG. 1 is a LCD joined screen with a GOA circuit in an existing art.

FIG. 2 is a schematic diagram illustrating a GOA circuit with single-directional outputs in an existing art.

FIG. 3 is a schematic diagram illustrating a GOA circuit with bidirectional outputs according to an embodiment of the present invention.

FIG. 4 is a schematic diagram illustrating a LCD seamlessly joined screen based on a GOA circuit with bidirectional outputs according to an embodiment of the present invention.

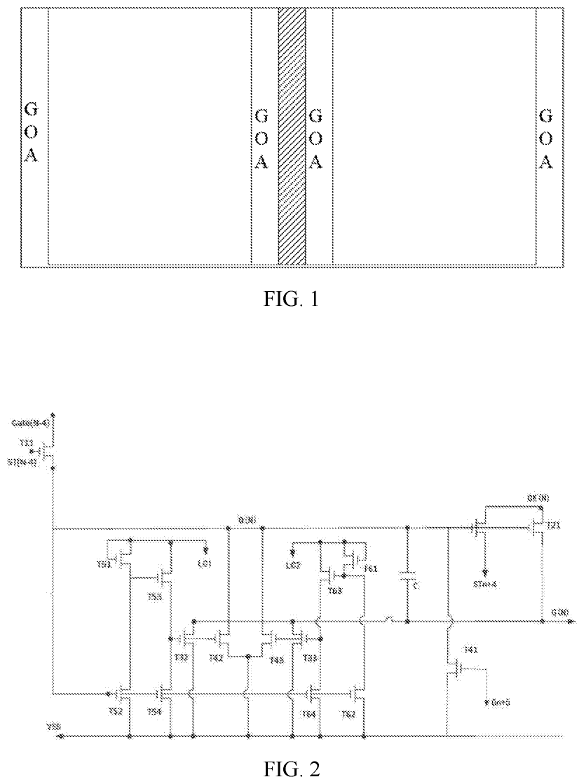

### DESCRIPTION OF EMBODIMENTS OF THE DISCLOSURE

To make those of ordinary skill in the art better understand the schemes of the present invention, the technical solutions in the embodiments of the present invention are clearly and completely described below with reference to appending drawings of the embodiments of the present invention. Obviously, the described embodiments are merely a part of embodiments of the present invention and are not all of the embodiments. Based on the embodiments of the present invention, other embodiments obtained by those of ordinary skill in the art without making any inventive effort are within the scope the present invention seeks to be protected.

It should be noted that in the specification, claims, and accompanying drawings of the present invention, the terms “first”, “second”, and so on are intended to distinguish between different objects rather than to indicate a specific order. Moreover, the terms “include”, “have” and any other variants mean to cover the non-exclusive inclusion. For example, in the context of a process, method, system, product or device that includes a series of steps or units, the process, method, system, product or device is not necessarily limited to the clearly listed steps or units, instead, includes other steps or units not specified clearly, or may include inherent steps or units of the process, method, product, or device.

The term “embodiment” or “implementation” referred to herein means that a particular feature, structure, or feature described in conjunction with the implementation may be contained in at least one implementation of the present invention. The phrase appearing in various places in the specification does not necessarily refer to the same implementation, nor does it refer to an independent or alternative implementation that is mutually exclusive with other implementations. It is expressly and implicitly understood by those skilled in the art that an implementation described herein may be combined with other implementations.

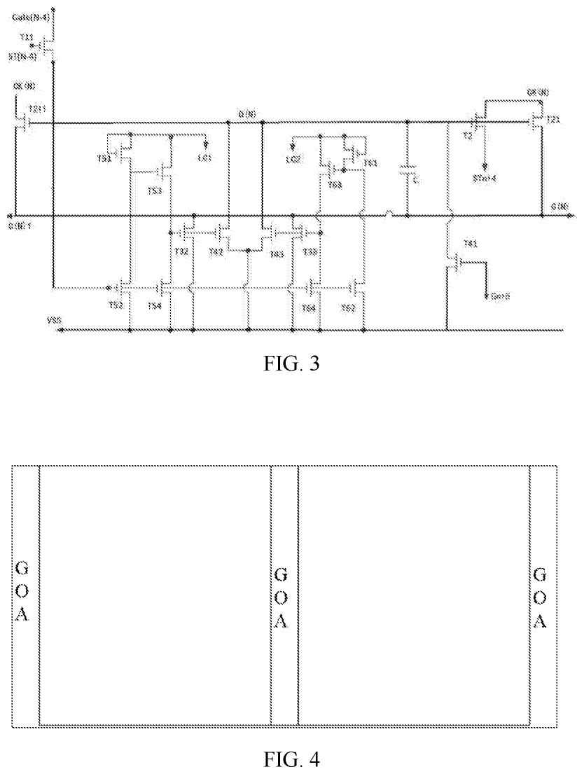

FIG. 3 is a schematic diagram illustrating an equivalent GOA circuit with bidirectional outputs according to an embodiment of the present invention. The GOA circuit includes a first circuit, a pull-up module, a first output end, a second output end, a capacitor C and a 41st transistor T41; the capacitor C and the second output end are connected in parallel and the 41st transistor T41 and the first circuit are connected in parallel;

N is set to be a positive integer, in a Nth stage of the GOA circuit except for GOA units of a first stage and a last stage, the pull-up module is connected to the first circuit, the first circuit is connected to one of the first output end and the second output end, the first output end is connected to a pull-down module. The source of the 41st transistor T41 is connected to a signal of a Q node, the drain of the 41st transistor T41 is connected to a power supply (VSS), the gate of the 41st transistor is connected to a gate signal Gn+5, where both of n and N represent a stage of a GOA unit.

In the GOA circuit with bidirectional outputs according to the present invention, the pull-up module includes an eleventh transistor T11, the gate of the eleventh transistor T11 is connected to a serial telecommunication (ST) signal ST(N−4), the source of the eleventh transistor T11 is connected to a gate signal Gate(N−4), the drain of the eleventh transistor T11 is connected to the first circuit.

In the GOA circuit with bidirectional outputs according to the present invention, the first circuit includes a first mirror circuit and a second mirror circuit; the first mirror circuit and the second mirror circuit are connected in parallel.

In the GOA circuit with bidirectional outputs according to the present invention, the first mirror circuit includes a 51st transistor T51, a 52nd transistor T52, a 53rd transistor T53 and a 54th transistor T54, wherein the gate of the 52nd transistor T52 is connected to the drain of the eleventh transistor T11, the source of the eleventh transistor T11 is connected to the gate signal Gate(N−4), the drain of the 52nd transistor T52 is connected to the power supply (VSS), the source of the 52nd transistor T52 is connected to the drain of the 51st transistor T51, the gate of the 51st transistor T51 is connected to the source of the 51st transistor T51, the gate of the 53rd transistor T53 is connected to the drain of the 51st transistor T51, the source of the 51st transistor T51 and the source of the 53rd transistor T53 are connected to a LC1 signal (i.e., an oscillation signal), wherein the gate of the 54th transistor T54 is connected to the drain of the eleventh transistor T11, the source of the 54th transistor T54 is connected to the drain of the 53rd transistor T53, the drain of the 54th transistor T54 is connected to the power supply (VSS).

In the GOA circuit with bidirectional outputs according to the present invention, the first mirror circuit further includes a 32nd transistor T32 and a 42nd transistor T42, wherein the gate of the 32nd transistor T32 is connected to the source of the 54th transistor T54, the source of the 32nd transistor T32 is connected to the first output end, the drain of the 32nd transistor T32 is connected to the power supply (VSS), wherein the gate of the 42nd transistor T42 is connected to the source of the 54th transistor T54, the source of the 42nd transistor T42 is connected to the signal of the Q node, the drain of the 42nd transistor T42 is connected to the power supply (VSS).

In the GOA circuit with bidirectional outputs according to the present invention, the second mirror circuit includes a 61st transistor T61, a 62nd transistor T62, a 63rd transistor T63 and a 64th transistor T64, wherein the drain of the 61st transistor T61 is connected to the gate of the 63rd transistor T63, the gate of the 61st transistor T61 is connected to the source of the 61st transistor T61, the source of the 63rd transistor T63 is connected to the source of the 61st transistor T61 and a LC2 signal, the drain of the 63rd transistor T63 is connected to the source of the 64th transistor T64, the gate of the 64th transistor T64 is connected to the drain of the eleventh transistor T11, the drain of the 64th transistor T64 is connected to the power supply (VSS), the gate of the 62nd transistor T62 is connected to the drain of the eleventh transistor T11, the source of the 62nd transistor T62 is connected to the drain of the 61st transistor T61, the drain of the 62nd transistor T62 is connected to the power supply (VSS).

In the GOA circuit with bidirectional outputs according to the present invention, the second mirror circuit further includes a 43rd transistor T43 and a 33rd transistor T33, wherein the gate of the 33rd transistor T33 is connected to the source of the 64th transistor T64, the source of the 33rd transistor T33 is connected to the first output end, the drain of the 33rd transistor T33 is connected to the power supply (VSS), the gate of the 43rd transistor T43 is connected to the source of the 64th transistor T64, the source of the 43rd transistor T43 is connected to the signal of the Q node, the drain of the 43rd transistor T43 is connected to the power supply (VS S).

In the GOA circuit with bidirectional outputs according to the present invention, the GOA circuit further includes a 211th transistor T211, wherein the gate of the 211th transistor T211 is connected to the signal of the Q node, the source of the 211th transistor T211 is connected to a clock signal CK(N), the drain of the 211th transistor T211 is connected to the first output end G(N)1.

In the GOA circuit with bidirectional outputs according to the present invention, the GOA circuit further includes a second transistor T2 and a 21st transistor T21, wherein the gate of the second transistor T2 and the gate of the 21st transistor T21 are connected to the signal of the Q node, the source of the second transistor T2 is connected to the source of the 21st transistor T21, the drain of the second transistor T2 is connected to a STn+4 signal (serial telecommunication signal), the drain of the 21st transistor T21 is connected to the second output end G(N).

FIG. 4 is a schematic diagram illustrating a liquid crystal display (LCD) seamlessly joined screen based on a GOA circuit with bidirectional outputs according to an embodiment of the present invention. The seamlessly joined screen includes at least two pieces of display screens including the GOA circuit with bidirectional outputs, wherein the GOA circuit is configured to drive the at least two pieces of display screens to display images and is disposed between the at least two display screens.

The present invention discloses a GOA circuit with bidirectional outputs. The GOA circuit includes a first circuit, a pull-up module, a first output end, a second output end, a capacitor C and a 41st transistor T41; the capacitor C and the second output end are connected in parallel and the 41st transistor T41 and the first circuit are connected in parallel; The pull-up module is connected to the first circuit. The first circuit is connected to one of the first output end and the second output end. The first output end is connected to a pull-down module. The present invention further provides a seamlessly joined screen, which includes at least two pieces of display screens including the GOA circuit with bidirectional outputs. The seamlessly joined screen can solve the technical difficulty of a seamless design of the joined screen, greatly reduce the gap of the joined screen, improve its aesthetics and user experience, and at the same time reduce a cutting process for one time, improve the product yield and reduce the cost.

The above described device embodiments are only illustrative, and modules described as separate units for illustration may or may not be physically separated. Additionally, the units shown as respective modules may or may not be physical modules, that is, the units may be located in one place or may be distributed over a plurality of network modules). Apart or whole of the modules may be selected to realize the objectives of the schemes of the present embodiment depending on practical requirements. One of ordinary skill in the art will understand and implement the invention without creative work.

With the description of above embodiments, those skilled in the art can understand clearly that, each of the implementations can be carried out by means of software plus a necessary general-purpose hardware platform, and of course can be carried out by hardware. Based on such understanding, above technical solutions essentially or a part of the technical solutions which makes contribution to related arts can be embodied in a form of a software product, and the computer software product can be stored in a computer readable storage medium such as Read-Only Memory (ROM), Random Access Memory (RAM), Programmable Read-only Memory (PROM), Erasable Programmable Read Only Memory (EPROM), One-time Programmable Read-Only Memory (OTPROM), Electrically-Erasable Programmable Read-Only Memory (EEPROM), Compact Disc Read-Only Memory (CD-ROM), other optical disc storages, magnetic disc storages, magnetic tape storages, and any other computer readable medium capable of carrying or storing data.

It should be noted in the end that the disclosure of the GOA circuit with bidirectional outputs and the seamlessly joined screen disclosed in the embodiments of the present invention is directed only to a preferred mode of the present invention only for illustrating the technical solutions of the present invention, rather than imposing a limitation thereto. Although the disclosure has been described above in details with reference to the embodiments above, one of ordinary skill in the art shall appreciate that they can modify the technical solutions recited in the respective embodiments above or make equivalent substitutions to a part of the technical features thereof; and these modifications or substitutions to the corresponding technical solution shall also fall into the scope and spirit of the technical solutions of the respective embodiments.

1. A gate-on-array (GOA) circuit with bidirectional outputs, wherein the GOA circuit comprises a first circuit, an eleventh transistor, a first output end, a second output end, a capacitor, a 41st transistor, a 211th transistor, a second transistor and a 21st transistor; wherein the capacitor and the second output end are connected in parallel and the 41st transistor and the first circuit are connected in parallel;
wherein N is set to be a positive integer, in a Nth stage of the GOA circuit except for GOA units of a first stage and a last stage, a gate of the eleventh transistor is connected to a serial telecommunication (ST) signal, a source of the eleventh transistor is connected to a gate signal, a drain of the eleventh transistor is connected to the first circuit, the first circuit is connected to one of the first output end and the second output end, the first output end is connected to a pull-down module, the gate of the 211th transistor is connected to a signal of a Q node, the source of the 211th transistor is connected to a clock signal, the drain of the 211th transistor is connected to the first output end, the gate of the second transistor and the gate of the 21st transistor are connected to the signal of the Q node, the source of the second transistor is connected to the source of the 21st transistor, the drain of the second transistor is connected to the ST signal, the drain of the 21st transistor is connected to the second output end.

2. The circuit according to claim 1, wherein the first circuit comprises a first mirror circuit and a second mirror circuit that are connected in parallel.

3. A gate-on-array (GOA) circuit with bidirectional outputs, wherein the GOA circuit comprises a first circuit, a pull-up module, a first output end, a second output end, a capacitor and a 41st transistor; wherein the capacitor and the second output end are connected in parallel and the 41st transistor and the first circuit are connected in parallel;
wherein N is set to be a positive integer, in a Nth stage of the GOA circuit except for GOA units of a first stage and a last stage, the pull-up module is connected to the first circuit, the first circuit is connected to one of the first output end and the second output end, the first output end is connected to a pull-down module.

4. The circuit according to claim 3, wherein the pull-up module comprises an eleventh transistor, the gate of the eleventh transistor is connected to a serial telecommunication (ST) signal, the source of the eleventh transistor is connected to a gate signal, the drain of the eleventh transistor is connected to the first circuit.

5. The circuit according to claim 4, wherein the first circuit comprises a first mirror circuit and a second mirror circuit that are connected in parallel.

6. The circuit according to claim 5, wherein the first mirror circuit comprises a 51st transistor, a 52nd transistor, a 53rd transistor and a 54th transistor, wherein the gate of the 52nd transistor is connected to the drain of the eleventh transistor, the drain of the 52nd transistor is connected to a power supply (VSS), the source of the 52nd transistor is connected to the drain of the 51st transistor, the gate of the 51st transistor is connected to the source of the 51st transistor, the gate of the 53rd transistor is connected to the drain of the 51st transistor, the source of the 51st transistor and the source of the 53rd transistor are connected to a LC1 signal, wherein the gate of the 54th transistor is connected to the drain of the eleventh transistor, the source of the 54th transistor is connected to the drain of the 53rd transistor, the drain of the 54th transistor is connected to the power supply (VSS).

7. The circuit according to claim 6, wherein the first mirror circuit further comprises a 32nd transistor and a 42nd transistor, wherein the gate of the 32nd transistor is connected to the source of the 54th transistor, the source of the 32nd transistor is connected to the first output end, the drain of the 32nd transistor is connected to the power supply (VSS), wherein the gate of the 42nd transistor is connected to the source of the 54th transistor, the drain of the 42nd transistor is connected to the signal of the Q node, the drain of the 42nd transistor is connected to the power supply (VSS).

8. The circuit according to claim 5, wherein the second mirror circuit comprises a 61st transistor, a 62nd transistor, a 63rd transistor and a 64th transistor, wherein the drain of the 61st transistor is connected to the gate of the 63rd transistor, the gate of the 61st transistor is connected to the source of the 61st transistor, the source of the 63rd transistor is connected to the source of the 61st transistor and a LC2 signal, the drain of the 63rd transistor is connected to the source of the 64th transistor, the gate of the 64th transistor is connected to the drain of the eleventh transistor, the drain of the 64th transistor is connected to the power supply (VSS), the gate of the 62nd transistor is connected to the drain of the eleventh transistor, the source of the 62nd transistor is connected to the drain of the 61st transistor, the drain of the 62nd transistor is connected to the power supply (VSS).

9. The circuit according to claim 8, wherein the second mirror circuit further comprises a 43rd transistor and a 33rd transistor, wherein the gate of the 33rd transistor is connected to the source of the 64th transistor, the source of the 33rd transistor is connected to the first output end, the drain of the 33rd transistor is connected to the power supply (VSS), the gate of the 43rd transistor is connected to the source of the 64th transistor, the source of the 43rd transistor is connected to the signal of the Q node, the drain of the 43rd transistor is connected to the power supply (VSS).

10. The circuit according to claim 3, further comprising a 211th transistor, wherein the gate of the 211th transistor is connected to the signal of the Q node, the source of the 211th transistor is connected to a clock signal, the drain of the 211th transistor is connected to the first output end.

11. The circuit according to claim 3, further comprising a second transistor and a 21st transistor, wherein the gate of the second transistor and the gate of the 21st transistor are connected to the signal of the Q node, the source of the second transistor is connected to the source of the 21st transistor, the drain of the second transistor is connected to a serial telecommunication (ST) signal, the drain of the 21st transistor is connected to the second output end.

12. A seamlessly joined screen, wherein the seamlessly joined screen comprises at least two pieces of display screens comprising a gate-on-array (GOA) circuit with bidirectional outputs, wherein the GOA circuit is configured to drive the at least two pieces of display screens to display images and is disposed between the at least two display screens, wherein the GOA circuit comprises a first circuit, a pull-up module, a first output end, a second output end, a capacitor and a 41st transistor, wherein the capacitor and the second output end are connected in parallel and the 41st transistor and the first circuit are connected in parallel;
wherein N is set to be a positive integer, in a Nth stage of the GOA circuit except for GOA units of a first stage and a last stage, the pull-up module is connected to the first circuit, the first circuit is connected to one of the first output end and the second output end, the first output end is connected to a pull-down module.

13. The seamlessly joined screen according to claim 12, wherein the pull-up module comprises an eleventh transistor, the gate of the eleventh transistor is connected to a serial telecommunication (ST) signal, the source of the eleventh transistor is connected to a gate signal, the drain of the eleventh transistor is connected to the first circuit.

14. The seamlessly joined screen according to claim 13, wherein the first circuit comprises a first mirror circuit and a second mirror circuit that are connected in parallel.

15. The seamlessly joined screen according to claim 14, wherein the first mirror circuit comprises a 51st transistor, a 52nd transistor, a 53rd transistor and a 54th transistor, wherein the gate of the 52nd transistor is connected to the drain of the eleventh transistor, the drain of the 52nd transistor is connected to a power supply (VSS), the source of the 52nd transistor is connected to the drain of the 51st transistor, the gate of the 51st transistor is connected to the source of the 51st transistor, the gate of the 53rd transistor is connected to the drain of the 51st transistor, the source of the 51st transistor and the source of the 53rd transistor are connected to a LC1 signal, wherein the gate of the 54th transistor is connected to the drain of the eleventh transistor, the source of the 54th transistor is connected to the drain of the 53rd transistor, the drain of the 54th transistor is connected to the power supply (VSS).

16. The seamlessly joined screen according to claim 15, wherein the first mirror circuit further comprises a 32nd transistor and a 42nd transistor, wherein the gate of the 32nd transistor is connected to the source of the 54th transistor, the source of the 32nd transistor is connected to the first output end, the drain of the 32nd transistor is connected to the power supply (VSS), wherein the gate of the 42nd transistor is connected to the source of the 54th transistor, the drain of the 42nd transistor is connected to the signal of the Q node, the drain of the 42nd transistor is connected to the power supply (VSS).

17. The circuit according to claim 14, wherein the second mirror circuit comprises a 61st transistor, a 62nd transistor, a 63rd transistor and a 64th transistor, wherein the drain of the 61st transistor is connected to the gate of the 63rd transistor, the gate of the 61st transistor is connected to the source of the 61st transistor, the source of the 63rd transistor is connected to the source of the 61st transistor and a LC2 signal, the drain of the 63rd transistor is connected to the source of the 64th transistor, the gate of the 64th transistor is connected to the drain of the eleventh transistor, the drain of the 64th transistor is connected to the power supply (VSS), the gate of the 62nd transistor is connected to the drain of the eleventh transistor, the source of the 62nd transistor is connected to the drain of the 61st transistor, the drain of the 62nd transistor is connected to the power supply (VS S).

18. The seamlessly-joined screen according to claim 17, wherein the second mirror circuit further comprises a 43rd transistor and a 33rd transistor, wherein the gate of the 33rd transistor is connected to the source of the 64th transistor, the source of the 33rd transistor is connected to the first output end, the drain of the 33rd transistor is connected to the power supply (VSS), the gate of the 43rd transistor is connected to the source of the 64th transistor, the source of the 43rd transistor is connected to the signal of the Q node, the drain of the 43rd transistor is connected to the power supply (VSS).

19. The seamlessly joined screen according to claim 12, further comprising a 211th transistor, wherein the gate of the 211th transistor is connected to the signal of the Q node, the source of the 211th transistor is connected to a clock signal, the drain of the 211th transistor is connected to the first output end.

20. The seamlessly joined screen according to claim 12, further comprising a second transistor and a 21st transistor, wherein the gate of the second transistor and the gate of the 21st transistor are connected to the signal of the Q node, the source of the second transistor is connected to the source of the 21st transistor, the drain of the second transistor is connected to a serial telecommunication (ST) signal, the drain of the 21st transistor is connected to the second output end.
